(19) United States
(12) Patent Application Publication
(10) Pub. No.: US 2010/0132161 A1
(43) Pub. Date: Jun. 3, 2010

(54) Door stop assembly

(76) Inventor: Dac Vu, Tustin, CA (US)

Correspondence Address: Dac Vu;Suite 208, 3002 Dow Avenue, Tustin, CA, 92780, US

(21) Appl. No.: 12/315,244

(22) Filed: Dec. 1, 2008

(51) Int. Cl. E05F 5/00

(52) U.S. Cl. 16/404

(57) ABSTRACT

Door stops are generally discussed herein for stopping door knobs or other door hardware from slamming against a wall with particular discussions on door stops having dampening means. Aspects of the door stop assemblies discussed herein include the use of a helical coil spring spacer for delimiting movement of a door and either a pliable insert or an outer sheath or both for dampening the spring when the same is impacted. A combination magnet and magnetically attractable plate or two magnets with opposite magnetic poles may be used to temporary secure a door in a fixed position.

Door stops are generally discussed herein for stopping door knobs or other door hardware from slamming against a wall with particular discussions on door stops having dampening means and optionally magnetic means.

### BACKGROUND

As is well known in the art, a door stop is a device mounted to a baseboard, a wall, or a door for stopping the door's hardware, such as a door knob, from slamming into and ruining the wall. The length of the door stop's spacer, measured from its base to its tip, is longer than the length of the door knob's projection from the surface of the door. In addition, its tip incorporates a blunt end having a surface area sized to generate less force when impacted by the door than the force generated by the door knob against the wall in the absence of the door stop.

Also well known in the art is the use of magnets to maintain doors in their fixed open positions. Typically a magnet, either mounted to a door or a wall, is used with a strike plate, mounted to the other one of the door or the wall, to generate a holding force. Once the magnet retrains the door in an open position, closing it will cause a loud spring resonance. Accordingly, there is a need for a magnetic door stop for maintaining a door in its fixed open position that has dampening capabilities to reduce spring vibration. There is also a need for a simple door stop with dampening capabilities.

### SUMMARY OF THE PREFERRED EMBODIMENTS

The present invention may be implemented by providing a door stop assembly for preventing door slams comprising: a spring spacer comprising three or more consecutively formed helical coils defining an interior space, a free end comprising a first diameter, and a fixed end comprising a larger second diameter; a flexible and pliable absorber for dampening the spring spacer, the absorber being in contact with and configured to constrain the three or more consecutive helical coils of the spring spacer to dampen the spring spacer along a portion of the spring spacer closer to the fixed end than the free end; and wherein the absorber comprises a proximal end comprising a proximal diameter and a distal end comprising a distal diameter, wherein the proximal diameter is larger than the distal diameter.

In yet other aspects of the present invention, there is provided a door stop assembly for preventing door slams comprising: a spring spacer comprising a plurality consecutively formed helical coils comprising a frusto-conical section; a flexible and pliable absorber having a frusto-conical section; and wherein the frusto-conical section of the absorber is in contact with and adapted to constrain at least a portion of the frusto-conical section of the spring spacer to dampen the spring spacer.

In still yet other aspects of the present invention, there is provided a door stop assembly for preventing door slams comprising: a spring spacer comprising a fixed end, a free end, a middle section in between the fixed end and the free end, and a plurality of consecutively formed helical coils defining an interior space; a mounting bracket receiving a portion of the spring spacer at the fixed end of the spring spacer; a cap fitted over and in contact with a portion of the free end of the spring spacer; and a flexible and pliable absorber for dampening the spring spacer, the absorber being in contact with the spring spacer along a length of the spring spacer from its fixed end to its middle section.

Aspects of the present invention include a method for preventing door slams comprising: inserting a flexible and pliable absorber into a spring spacer comprising a plurality of helical coils comprising an inside surface defining an interior cavity, the flexible and pliable absorber filling and in contact with at least a portion of the interior cavity of the spring spacer; and stopping a door from slamming again a wall with the spring spacer.

The spring spacer may also be used with both an insertable absorber and an external absorber in a form of a sheath.

In yet other aspects of the present invention, a magnet and a strike plate or two magnets may be used with the spring spacer, which can temporary fix a pivotable door in a fixed position.

Other aspects and features of the door stops provided herein may be better appreciated as the same become better understood with reference to the specification, claims, and appended drawings.

### BRIEF DESCRIPTION OF THE DRAWINGS

The appended drawings include:

FIG. 1 is a semi-schematic perspective view of a door stop assembly provided in accordance with aspects of the present invention;

FIG. 2 is a semi-schematic side view of a spacer unit provided in accordance with aspects of the present invention, which includes a mounting plate, a mounting screw, a spring spacer, and a pliable insert;

FIG. 3 is a semi-schematic cross-section side view of the spacer unit of FIG. 2 taken along line 3-3;

FIG. 4 is a semi-schematic side view of a cap having a magnet disposed therein attracted to a strike plate having a plate screw passing therethrough;

FIG. 5 is a semi-schematic cross-sectional side view of the components of FIG. 4 taken along line 5-5;

FIG. 6 is a cross-sectional side view of the door stop assembly of FIG. 1 mounted to a door and a base board;

FIG. 7 is a semi-schematic perspective view of a spacer unit provided in accordance with aspects of the present invention, which includes a pliable sheath configured to fit over spring spacer;

FIG. 8 is a semi-schematic side view of the spacer unit of FIG. 7 in an assembled state;

FIG. 9 is a semi-schematic cross-sectional side view of the spacer unit of FIG. 8 taken along line 9-9;

FIG. 10 is a cross-sectional side view of yet another alternative spacer unit provided in accordance with aspects of the present invention;

FIG. 11 is a perspective exploded view of still yet another alternative door stop assembly provided in accordance with aspects of the present invention;

FIG. 12 is a side view of a spacer unit of the door stop assembly of FIG. 11; and

FIG. 13 is a cross-section side view of the spacer unit of FIG. 12 taken along line A-A.

### DETAILED DESCRIPTION

The detailed description set forth below in connection with the appended drawings is intended as a description of the presently preferred embodiments of door stops provided in accordance with aspects of the present invention and is not intended to represent the only forms in which the present invention may be constructed or utilized. The description sets forth the features and the steps for constructing and using the door stops of the present invention in connection with the illustrated embodiments. It is to be understood, however, that the same or equivalent functions and structures may be accomplished by different embodiments that are also intended to be encompassed within the spirit and scope of the invention. Also, as denoted elsewhere herein, like element numbers are intended to indicate like or similar elements or features.

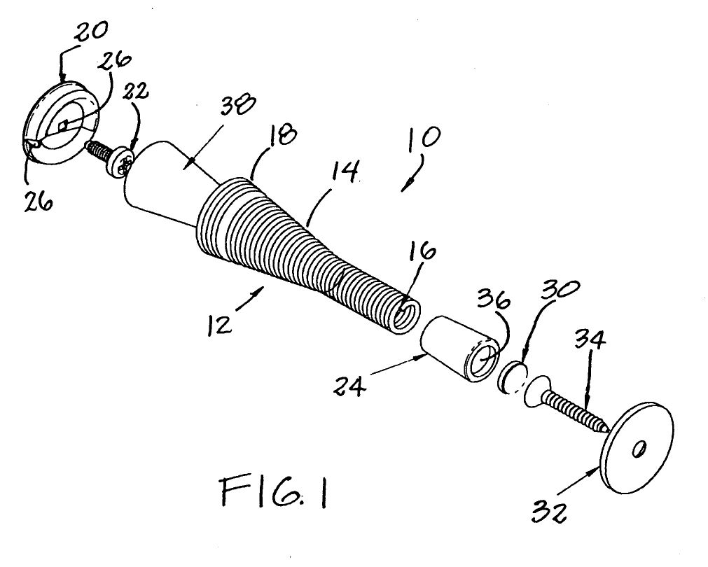

Referring now to FIG. 1, a semi-schematic exploded view of a door stop assembly provided in accordance with aspects of the present invention is shown, which is generally designated 10. In one exemplary embodiment, the door stop assembly 10 comprises a helical coil spring spacer 12 having a body 14 comprising a free end 16 and an attachment end 18 defining a length therebetween. The spring spacer 12 is well known in the art for use as a door stop device for a pivotable door. As is well known in the art, the length of the spring spacer 12 may vary depending on the particular door stop application, which generally depends on the hardware used, such as a door knob.

The door stop assembly 10 further comprises a mounting bracket 20, a mounting screw 22 for securing the mounting bracket 20 to a structure, such as a base board, and a cap 24 for capping the free end 16 of the spring spacer. The mounting bracket 20 typically incorporates a boss 26 for receiving the mounting screw 22 and a socket 26 for receiving a first loop or first helical coil of the spring spacer 12 to secure the spring spacer to the mounting bracket.

To generate a securing force to secure a door in an open position, a magnetic force may be used. In one exemplary embodiment, a combination magnet 30 and a magnetically attractable plate or strike plate 32 is incorporated. However, two magnets with opposite attractions may alternatively be used. As further discussed below, by mounting the magnet 30 to a spring spacer 12 and the strike plate 32 to a door (not shown), when the strike plate contacts the magnet, the magnetic force retains the strike plate to the magnet. Furthermore, because the strike plate is mounted to a door, the door is retained in the open position by the magnet. Alternatively, the spring spacer 12 may be mounted to a door and the strike plate to a fixed structure, such as a wall or a base board, without deviating from the spirit and scope of the present invention.

In one exemplary embodiment, a plate screw 34 is used to secure the strike plate 32 to a door and a receiving bore 36 is incorporated in the cap 24 to receive the magnet 30, using interference fit. Optionally, adhesive or a bonding agent may be used to more permanently secure the magnet to the cap. As is readily apparent to a person of ordinary skill in the art, a reverse mounting configuration wherein the magnet is mounted to a door and the strike plate is secured to the fixed structure may be employed without deviating from the spirit and scope of the present invention.

To dampen the spring spacer 12 when it deflects as a result of closing a door, as further discussed below, a flexible absorber 38 is used to absorb the vibration. In one exemplary embodiment, the flexible absorber 38 is a pliable insert configured to be inserted into the interior cavity of the spring spacer 12 (See also FIGS. 3 and 6). The flexible absorber is configured to reduce the magnitude of deflection and shorten the decay time of the amplitude displacement of the spring spacer when the same is impacted and vibrates. Usable materials for making a flexible absorber as provided in accordance with aspects of the present invention include sponge material, an elastomer foam, LDPE (low density polyethylene) foam, PVC foam, foam rubber, and cross-linked, closed-cell polyolefin foam. However, other thermoplastic elastomers not mentioned herein may be also used provided they are capable of cooperating with the spring spacer to produce a shorter decay time than without the insert. A characteristic of a preferred flexible absorber is pliability, or ability to rebound or return to or near its original shape.

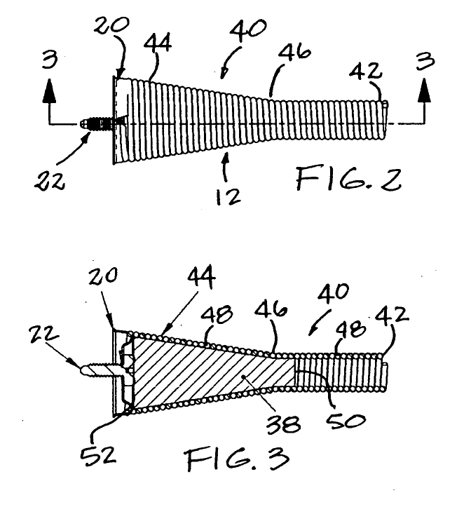

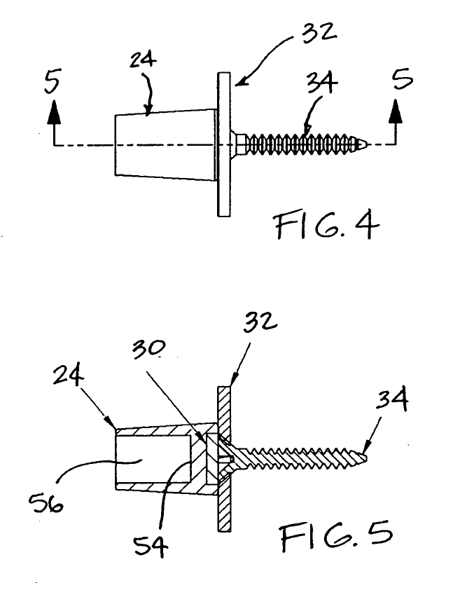

FIG. 2 is a semi-schematic side view of the spring body 12 attached to the mounting bracket 20 and the mounting screw 22 passing therethrough, which are collectively herein referred to as a spacer unit 40. The spacer unit 40 also includes the flexible insert 38 disposed internally of the spring spacer 12 (FIG. 3). In one exemplary embodiment, the spacer unit 40 may be secured to a fixed or non-moving structure, such as a wall or a base board. However, in certain applications, the spacer unit 40 may be secured to a movable structure, such as a door.

In one exemplary embodiment, the spring spacer 12 comprises a generally cylindrical distal portion 42 and a frusto-conical proximal portion 44 defining a transition zone 46 therebetween. However, a uniform cylinder throughout the length of the spacer or a frusto-conical shape spring spacer extending from the fixed end 18 to the free end 16 without a transition zone may be incorporated without deviating from the spirit and scope of the present invention.

FIG. 3 is a cross-sectional side view of the spacer unit 40 of FIG. 2 taken along line 3-3. The flexible insert 38 is shown stuffed into the internal space defined by the plurality of helical coils 48 of the spring spacer 12. In accordance with one aspect of the present invention, the flexible insert 38 is fabricated with the same shape as the spring spacer 38 and is slightly enlarged so as to produce a compression or interference fit when placed internally of the spring spacer. The interference is such that a slight or low resistance is produced upon inserting the pliable insert 38 into the internal space without undue demand or force. Said differently, the pliable insert 38 should substantially fill the internal space defined by the proximal portion 44 of the spring body. In a preferred embodiment, the pliable inset 38 should also fill a section of the distal portion 42 of the spring body near the transition zone 46. In a less preferred embodiment, a small space or gap exists between the insert and the spring spacer.

The pliable insert 38 comprises a length defined between the distally facing wall surface 50 and the proximally facing wall surface 52. In one exemplary embodiment, the length of the pliable insert 38 is sufficiently long such that upon inserting the first helical coil 48 of the fixed end of the spring spacer 12 into the mounting plate 20, a compression force is generated by the mounting plate 20 against the distally facing wall surface 52 of the pliable insert 38. However, a nominal gap or a surface contact between the mounting plate 20 and the proximally facing wall surface may be incorporated without deviating from the spirit and scope of the present invention.

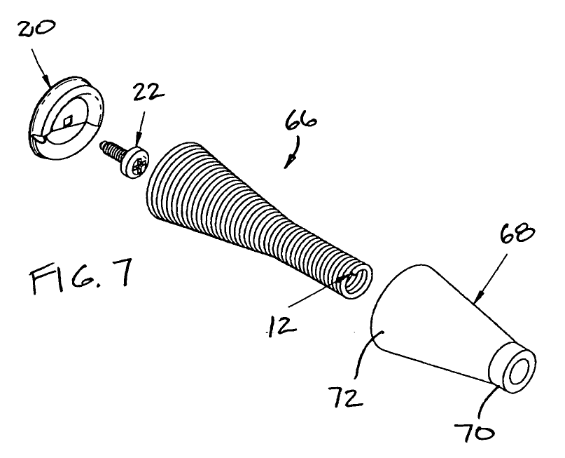

Thus, in accordance with aspects of the present invention, 3 or more consecutive coils 48 of a helical coil spring is restrained by a flexible absorber for reducing the decay time of the spring displacement of the spring spacer when the same is impacted and vibrates. As further discussed below with reference to FIGS. 7-9, the restraining force may be acted internally of the spring spacer or externally. By restraining, the absorber limits, prevents, or decreases the vibration and reduces the decay time of the spring spacer a measurable amount than if no absorber was used. Preferably, the dampening effect is produced by physical contact between the spring spacer and a flexible and pliable absorber, which can be internally or externally of the spring spacer or both.

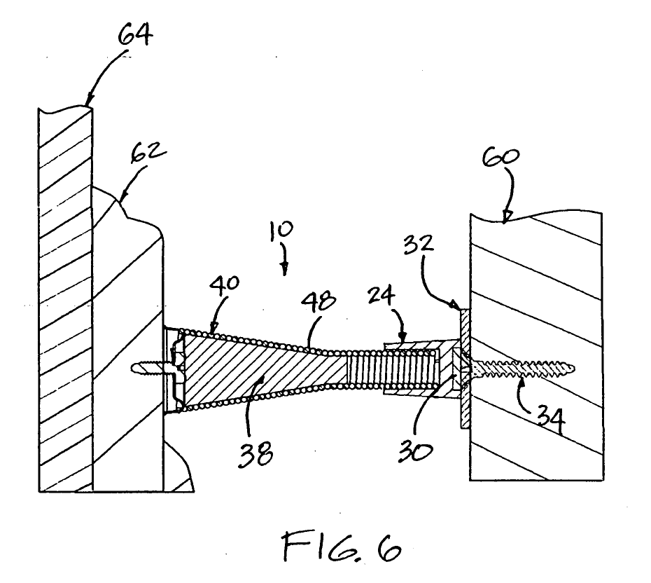

FIG. 4 is a semi-schematic side view showing a cap 24 in contact with a strike plate 32, which has a plate screw 34 passing therethrough. FIG. 4 is a depiction of an engaged position between a magnet (FIG. 5, 30) and the strike plate 32, shown without the other door stop components for clarity.

FIG. 5 is a cross-sectional side view of the components of FIG. 4, taken along line 5-5. In one exemplary embodiment, the cap 24 incorporates an internal web 54, which separates the internal cavity of the cap 24 into a spring spacer receiving chamber 56 and a magnetic receiving chamber 58. As discussed previously, the magnetic receiving chamber 58 is configured to receive a magnet 30 and the spring spacer receiving chamber 56 is configured to receive the free end 16 of the spring spacer 12. The cap 24 may be molded from thermoplastic material, a thermoplastic elastomer material, or a rubber material.

FIG. 6 is a semi-schematic cross-sectional side view of a door stop assembly 10 as provided in accordance with aspects of the present invention mounted to a door 60 and a baseboard 62, which is connected to a wall 64. More specifically, the strike plate 32 is mounted to the door and the spacer unit 40 is mounted to the baseboard 62. The combination cap 24 and magnet 30 is positioned over the spring spacer 12. The door stop assembly 10 should be aligned so that as door swings to its fully opened position, the magnet 30 strikes the strike plate 32 and the magnetic force from the magnet 30 retains the two by magnetic attraction.

The strike plate 32 may be separated from the magnet 30 simply by swinging the door closed and moving the strike plate 32 away from the magnet 30. Because of the magnetic force, the separation causes the spring spacer 12 to deflect. However, because of the pliable insert 38 provided in accordance with aspects of the present invention, the sound generated and the vibration produced is minimized. Said differently, the vibrating helical coils are constrained by the pliable absorber.

FIG. 7 is a spacer unit 66 provided in accordance with yet another aspect of the present invention. In one exemplary embodiment, the spacer unit 66 comprises a spring spacer 12, a mounting bracket 20, and a mounting screw 22 for securing the mounting bracket to a structure, such as a baseboard, wall, or door. The spacer unit 66 also incorporates a flexible absorber for dampening the spring spacer. However, rather than a pliable insert, the present embodiment utilizes a pliable sleeve or sheath 68 as a dampening absorber in the form of an overcoat. In one exemplary embodiment, the pliable sheath incorporates a distal portion 70 and a proximal portion 72 that correspond to the contour of the distal and proximal portions of the spring spacer 12. More preferably, the sheath 68 is sized such that it fits over the spring spacer 12 in a stretched fit, i.e., interference fit.

In one exemplary embodiment, the pliable sheath 68 is made from a pliable elastomer. More preferably, the sheath 68 is made from a thermoplastic elastomer (TPE) and is both resilient and pliable. Optionally, the sheath may be textured, colored, or transparent to provide an aesthetic appeal. For example, the sheath may have the same color as the wall color, as the baseboard color, or a distinct color to draw attention to the door stop, either for aesthetic or other reasons. Thus, in accordance with aspects of the present invention, any color among the spectrum of colors may be incorporated for the color of the sheath.

FIG. 8 is a semi-schematic side view of the spacer unit 66 provided in accordance with aspects of the present invention. The spacer unit 66 is shown without a cap, a magnet, and without the strike plate. In one exemplary embodiment, the sheath 68 surrounds the entire proximal portion 44 (See, e.g., FIG. 2) of the spring spacer 12 and a portion of the distal portion 42 near the transition zone 46. In an alternative embodiment, the sheath 68 can extend the entire distal portion 42 of the spring spacer 12 or any amount or length therebetween. In one aspect of the present invention, the sheath 68 is formed with internal ribs or bumps (not shown) to facilitate engagement with the exterior surface of the spring spacer 12. This prevents or at least inhibits the sheath from sliding towards the free end of the spring spacer 12. In yet another alternative embodiment, the proximal end edge of the sheath 68 comprises a reduced collar (not shown). The reduced collar is adapted to wedge in between two adjacent helical coils, which prevents the sheath from sliding relative to the spring spacer.

FIG. 9 is a semi-schematic cross-sectional side view of the spacer unit 66 of FIG. 8 taken along line 9-9. As shown, the interior space 74 defined by the plurality of helical coils 48 is empty or hollow. The dampening is provided by the sheath acting on three or more of the helical coils 48 along an external surface of the spring spacer. The spacer unit 66 may be used in the same manner as the spacer unit 40 shown with reference to FIG. 6, i.e., with a cap, magnet, and strike plate.

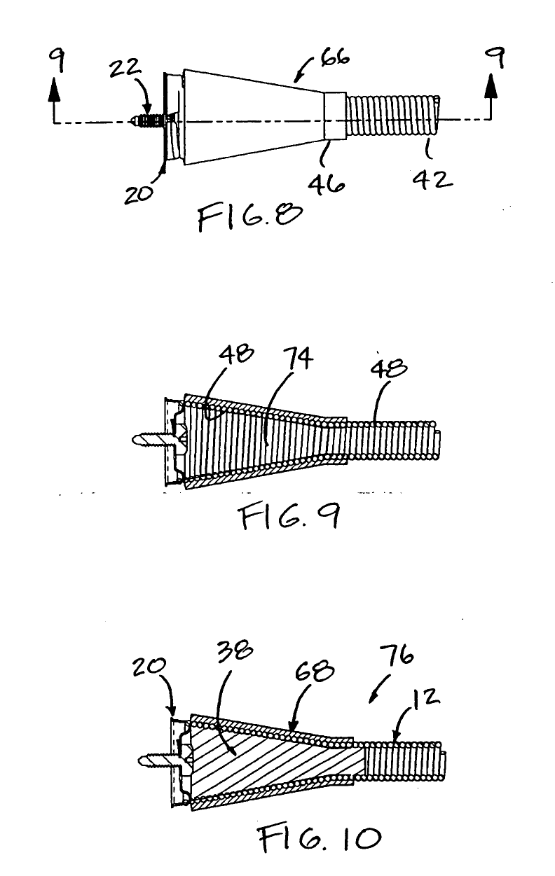

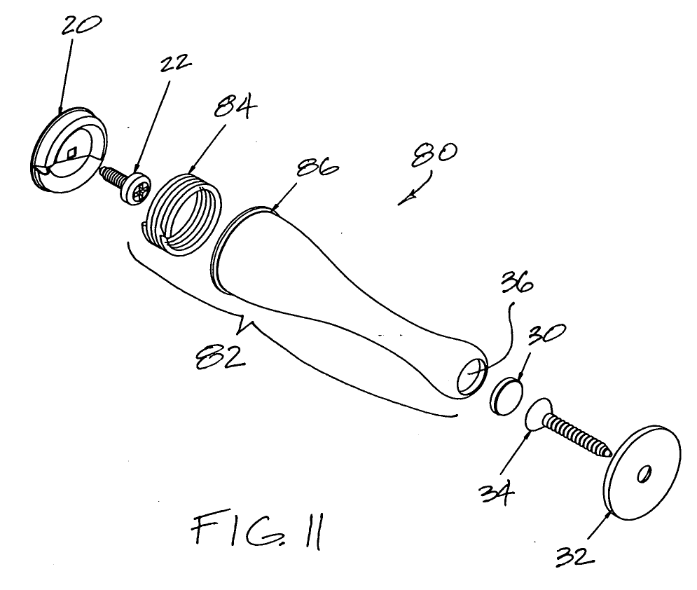

FIG. 10 is a semi-schematic cross-sectional side view of yet another alternative spacer unit 76 provided in accordance with aspects of the present invention. In the alternative embodiment, an insertable absorber 38, such as the one shown in FIG. 3, may be used in combination with a sheath 68 to provide added dampening. Still alternatively, the spacer unit 76, with or without an insertable absorber 38, may be used with a cap 24 (FIG. 1) but without a magnet or a strike plate. Yet still alternatively, the spacer unit 76 may be used in the same manner as the spacer unit 40 shown with reference to FIG. 6, i.e., with a cap, magnet, and strike plate.

FIG. 11 is a perspective exploded view of yet another door stop assembly 80 provided in accordance with aspects of the present invention. The present door stop assembly, like the other door stop assemblies discussed elsewhere herein, includes a mounting bracket 20, a mounting screw 22, a magnet 30, a plate screw 34, and a strike plate 32. However, in the present embodiment, the spacer function for preventing a door knob or handle from slamming against a structure or a wall and the vibration absorbing function are integrated into a combination molded spacer coil 82, which comprises a helical coil section 84 and a spacer 86. Broadly speaking, the combination molded spacer coil 82 may be used to replace the spring spacer 12, cap 24, and either a sleeve or an insert in the other disclosed door stop embodiments.

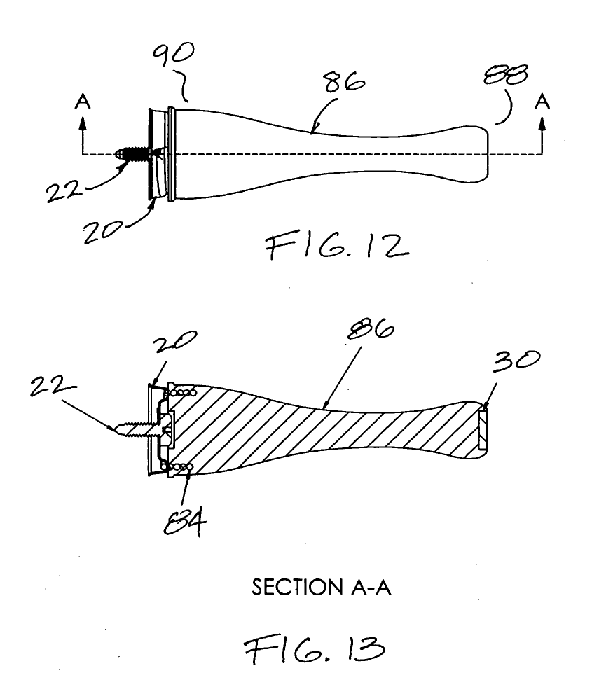

With reference to FIGS. 12 and 13 in addition to FIG. 11, in one embodiment, the spacer 86 is made from a rubber material and is over-molded to several of the coils of the helical coil section 84, such as 2-8 coils or more, with one or two coils of fractions thereof left exposed to enable engagement with the mounting bracket 20. Thus, the helical coil section 84 is relatively short and in one embodiment is short on the order of less than the length of the mounting screw 22 or the length of the plate screw 34.

The rubber may be made from a number of prior art rubber materials, such as acrylonitrile-butadiene rubber (NBR), hydrogenated acrylonitrile-butadiene rubber (HNBR), ethylene propylene diene rubber (EPDM), fluorocarbon rubber (FKM), chloroprene rubber (CR), silicone rubber (VMQ), fluorosilicone rubber (FVMQ), polyacrylate rubber (ACM), ethylene acrylic rubber (AEM), styrene-butadiene rubber (SBR), polyester urethane/polyether urethane (AU/EU), natural rubber, and polyurethane (PUR), as non-limiting examples. The rubber materials may individually be referred to as an elastomer or collectively as a class of elastomers. More preferably are rubber or elastomer materials that exhibit good resiliency, good tear strength resistance, heat aging resistance, and low price per unit. Materials of preferred characteristics include NBR, EPDM, CR, SBR, and NR.

Referring again to FIG. 11, the spacer 86 may be molded with a singularly formed receiving bore 36 for receiving a magnet 30. In one embodiment, the magnet 30 is co-molded with the spacer. In another embodiment, the magnet 30 is manually inserted into the receiving bore 36 following formation of the spacer. If the magnet 30 is subsequently inserted, glue, adhesive, and the like is used to more permanently secure the magnet to the spacer. The spacer is preferably solid in construction except for the distal end 88 in which a bore is provided and the proximal end 90 in which a cavity is formed as a bi-product of co-molding with the helical coil section 84. In an alternative embodiment, the distal end 36 is configured to receive a metal plate for attracting a magnet positioned where the strike plate 32 is shown in FIG. 11.

In one embodiment, the spacer 86 is molded to embody a shape of a bowling pin. In another embodiment, the spacer has a shape of a baseball bat. In another embodiment, the spacer has a shape of a tennis racket. More broadly speaking, because the spacer is molded from a rubber material, it can embody a number of shapes and sizes limited only by one's imagination. In one particular embodiment, the rubber is colored with colors other than black or may embody a combination of colors, such as a candy cane. Although the proximal end 90 of the spacer is generally wider in cross-section than the distal end 88, as shown in FIG. 13, in other embodiments, such as for a tennis racket, the distal end can be wider than the proximal end.

Accordingly, aspects of the present invention is a door stop assembly comprising a spacer made of a first material molded with a helical coil section of a second material and wherein at least one coil section of the helical coil section extends externally of the spacer for mounting to a mounting bracket. A further aspect of the present invention is a door stop assembly having a spacer having an exterior surface made of an elastomer material, a proximal end connected to a coil spring, and a distal end having a cavity for accommodating at least one of a metal material or a magnet. Most preferably, the spacer is unitarily formed with a distal end for accommodating at least one of a metal material or a magnet and a proximal end molded with a helical coil section in which at least a section of a coil is exposed and extends away from the spacer. The spacer may also be practiced without a magnet or without a plate for use with a magnet.

The present invention is further understood to include a spacer unit having dampening characteristics that easily fit into existing prior art mounting brackets thus enabling retrofitting of existing door stops with door stops of the present invention easily and effectively. As such, it is contemplated that a pack or package comprising a plurality of door stops having spring spacers or spacers as provided herein with dampening characteristics. The packs enable a home owner, tenant, or worker to easily swap out non-dampening spring spacers with dampening spacers.

Although limited embodiments of the door stop assemblies and their components have been specifically described and illustrated herein, many modifications and variations will be apparent to those skilled in the art. For example, the geometry (i.e., size, shape, thickness) of the spring spacer may be different, the helical coils may be larger or smaller, and the materials selected for the pliable insert or pliable sheath may be other than as expressly described provided they dampen the vibration amplitude of the spring in accordance with the teachings of the present invention. In addition, the door stop assembly may be used without the combination magnet and strike plate. Thus, a pliable insert or a pliable sheath may be used with a prior art spring spacer to minimize vibration but not retain a door in a fixed open position. Still alternatively, a spring spacer may be continuously formed but not singularly or integrally formed, i.e., with an attachment or seam for joining two or more pieces together. In yet another alternative embodiment, the spacer unit could be insert molded with a flexible and pliable body, without helical coils. A magnet and a mounting screw could be mounted with the insert molded body. For example, the entire unit could be made from a pliable TPE material having a magnet insert molded therewith. The mounting screw could also be formed therewith to attach to a baseboard without a mounting bracket. Accordingly, it is to be understood that the door stop assemblies and their components constructed according to principles of this invention may be embodied other than as specifically described herein. The invention is also defined in the following claims.

What is claimed is:

1. A door stop assembly for preventing door slams comprising:
a spring spacer comprising three or more consecutively formed helical coils defining an interior space, a free end comprising a first diameter, and a fixed end comprising a larger second diameter;
a flexible and pliable absorber for dampening the spring spacer, the absorber being in contact with and configured to constrain the three or more consecutive helical coils of the spring spacer to dampen the spring spacer along a portion of the spring spacer closer to the fixed end than the free end; and
wherein the absorber comprises a proximal end comprising a proximal diameter and a distal end comprising a distal diameter, wherein the proximal diameter is larger than the distal diameter.

2. The door stop assembly of claim 1, wherein the absorber is an insertable dampener positioned in the interior space of the spring spacer.

3. The door stop assembly of claim 1, wherein the absorber is a sheath fitted over the spring spacer.

4. The door stop assembly of claim 2, further comprising a sheath fitted over the spring spacer.

5. The door stop assembly of claim 1, further comprising a cap fitted over and in contact with the free end of the spring spacer.

6. The door stop assembly of claim 5, wherein the cap comprises an internal webbing and an open end having a magnet.

7. The door stop assembly of claim 1, wherein the fixed end of the spring spacer is fixed to a pivotable door or a wall of a roofed structure.

8. A door stop assembly for preventing door slams comprising:
a spacer comprising a plurality consecutively formed helical coils comprising a frusto-conical section;
a flexible and pliable absorber having a frusto-conical section; and
wherein the frusto-conical section of the absorber is in contact with and adapted to constrain at least a portion of the frusto-conical section of the spring spacer to dampen the spring spacer.

9. The door stop assembly of claim 8, wherein the absorber is selected from the group consisting of an insertable dampener and a sheath.

10. The door stop assembly of claim 8, wherein the absorber is an insert positioned inside the spring spacer, and wherein a sheath is fitted over the spring spacer.

11. The door stop assembly of claim 8, wherein the spring spacer comprises a fixed end and a free end, and wherein the fixed end is fixed to a pivotable door or a wall of a roofed structure.

12. The door stop assembly of claim 11, further comprising a mounting plate and wherein the fixed end of the spring spacer is in mechanical contact with the mounting plate.

13. The door stop assembly of claim 10, wherein the insert is made from a foam material.

14. A door stop assembly for preventing door slams comprising:
a spacer comprising a fixed end, a free end, a middle section in between the fixed end and the free end, and a plurality of consecutively formed helical coils;
a mounting bracket receiving a portion of the spring spacer at the fixed end of the spacer;
a receiving bore at the free end sized to accommodate at least one of a metal insert and a magnet; and
wherein the middle section comprises a wall section comprising an exterior surface comprising an elastomer material.

15. The door stop assembly of claim 14, wherein the spacer is molded with the plurality of consecutively formed helical coils.

16. The door stop assembly of claim 14, wherein the middle section is a sheath.

17. The door stop assembly of claim 15, wherein the sheath is fitted over the spacer.

18. The door stop assembly of claim 14, wherein the receiving bore is singularly formed to the middle section.

19. The door stop assembly of claim 14, wherein the spacer is made of an elastomer material.

20. The door stop assembly of claim 19, wherein at least a section of a coil of the plurality of consecutively formed helical coils is exposed and extends away from the fixed end of the spacer.
